(19) United States
(12) Patent Application Publication
(10) Pub. No.: US 2022/0196201 A1
(43) Pub. Date: Jun. 23, 2022

(54) DEVICE MOUNTING SYSTEM COMPRISING REMOTE ADJUSTMENT

(71) Applicant: Vics-Picks, Inc., Southport, NC (US)

(72) Inventor: VICTOR R. ROSADO, SOUTHPORT, NC (US)

(73) Assignee: Vics-Picks, Inc., Southport, NC (US)

(21) Appl. No.: 17/125,774

(22) Filed: Dec. 17, 2020

(51) Int. Cl. F16M 11/06; H04N 5/64; A47B 81/06; F16M 11/18

(52) U.S. Cl. CPC F16M 11/06; F16M 11/18; A47B 81/06; H04N 5/64

(57) ABSTRACT

The presently disclosed subject matter is generally directed to a mounting system capable of allowing the user to remotely adjust the position of a television or other electrical device. The mounting system includes support bracket, device bracket, adjustment arm, or any other element that allows a device to be releasably attached to the disclosed system. The adjustment arms have the capability to move the device in an upward, downward, left, and right direction, as well as tilt and swivel the device as desired by the user using a corresponding controller. Advantageously, the mounting system allows a user to remotely operate the mounting system. In this way, the device can be extended to and from the support wall, tilted up and down, and swiveled or moved left and right using remote user input.

### TECHNICAL FIELD

The presently disclosed subject matter is generally directed to a mounting system that can be used to mount a device to a support surface, such as a wall. The disclosed system can be adjusted using a controller to alter the positioning and orientation of the device remotely.

### BACKGROUND

With recent technological advances, flat screen televisions have become increasingly popular. Not only are the pictures getting brighter and clearer, but the television itself is thin, portable, and lightweight. The development of flat screen televisions therefore offers the opportunity to replace large television sets with displays having the same screen area but with a fraction of the depth and weight. As a result, flat screen televisions are versatile and can be easily and conveniently mounted on a wall for optimal viewing. Conventional wall mounts allow the television to be tilted up or down and moved away from the supporting wall. However, when a user wishes to change the television screen position, it must be manually adjusted. This can be time consuming and aggravating to the consumer. Further, many attempts may be required before the desired television tilt or position is achieved. It would therefore be beneficial to provide a wall mounting system capable of allowing the user to remotely adjust the position of the television (e.g., distance from the wall, tilt, swivel).

### SUMMARY

In some embodiments, the presently disclosed subject matter is directed to a device mounting system. Particularly, the mounting system comprises a support bracket defined by a front face and an opposed rear face, wherein the rear face is configured to releasably attach to a support. The mounting system further includes a device bracket that comprises a front face and an opposed rear face, wherein the front face is configured to releasably attach to a device. The mounting system comprises one or more adjustable arms defined by a first end attached to the front face of the support bracket and a second end attached to the rear face of the device bracket. The system includes an actuator capable of moving the arm in a variety of positions, a receiver capable of receiving signals from a controller and capable of giving instructions to the actuator, and a controller configured to remotely communicate with the receiver to control movement of the adjustable arm as desired by the user. The adjustable arm is configured to move the device in an upward direction, downward direction, tilted direction, swivel direction, or combinations thereof in response to input from the controller.

In some embodiments, the device is selected from a television, gaming system screen, computer screen, stereo speaker, or combinations thereof.

In some embodiments, the system includes a plurality of adjustment arms.

In some embodiments, the adjustment arms are selected from a hinged configuration, straight configuration, a telescoping configuration, or combinations thereof.

In some embodiments, the actuator is configured to move the adjustment arm(s) to position the device up, down, left, right, or combinations thereof relative to the support.

In some embodiments, the actuator is configured to move the adjustment arm(s) to tilt the device up, down, or both. In some embodiments, the device is tilted at an acute angle or an obtuse angle.

In some embodiments, the actuator is configured to move the adjustment arm(s) to swivel the device to the right, left, or both. In some embodiments, the device is swiveled at an angle of about 1-70 degrees.

In some embodiments, the actuator is configured to move the adjustment arm(s) to tilt the device up, down, or both, and swivel the device left, right, or both.

In some embodiments, the controller is wireless.

In some embodiments, the controller includes memory selected from prior adjustable arm settings, weight of the device, timer, or combinations thereof.

In some embodiments, the system further includes one or more lights, speakers, outlets, or combinations thereof.

In some embodiments, the presently disclosed subject matter is directed to a method of remotely adjusting the position of a device. Particularly, the method comprises positioning the device on the disclosed mounting system. The method includes inputting information into the controller as desired by the user, wherein the inputted information is received by the receiver. The method further incudes moving the adjustment arm(s) to position the device in accordance with the information input into the controller, whereby the device is remotely adjusted.

### BRIEF DESCRIPTION OF THE DRAWINGS

FIG. 1a is a side plan view of a mounting system in use with a device in accordance with some embodiments of the presently disclosed subject matter.

FIG. 1b is a front plan view of a device with the disclosed mounting system installed on a rear face in accordance with some embodiments of the presently disclosed subject matter.

FIG. 2a is a top plan view of a support bracket in accordance with some embodiments of the presently disclosed subject matter.

FIG. 2b is a side plan view of a support bracket in accordance with some embodiments of the presently disclosed subject matter.

FIG. 2c is a side cross-sectional view of a support bracket mounted on a support surface in accordance with some embodiments of the presently disclosed subject matter.

FIG. 3a is a top plan view of a device bracket in accordance with some embodiments of the presently disclosed subject matter.

FIG. 3b is a side cross-sectional view of a device bracket mounted to the rear face of a device in accordance with some embodiments of the presently disclosed subject matter.

FIG. 3c is a side plan view of a device bracket with a mounted device in accordance with some embodiments of the presently disclosed subject matter.

FIG. 4a is a side plan view of a device arm in accordance with some embodiments of the presently disclosed subject matter.

FIG. 4b is a side plan view of a hinged device arm in accordance with some embodiments of the presently disclosed subject matter.

FIG. 4c is a side plan view of a telescoping arm in accordance with some embodiments of the presently disclosed subject matter.

FIG. 5 is a side plan view of a mounting system with an extended arm in accordance with some embodiments of the presently disclosed subject matter.

FIGS. 6a and 6b illustrate one embodiment of the mounting system extending toward and away from a support surface in accordance with some embodiments of the presently disclosed subject matter.

FIGS. 6c and 6d illustrate one embodiment of the mounting system extending toward and away from a support surface in accordance with some embodiments of the presently disclosed subject matter.

FIG. 7a is a side view of a non-tilted device in accordance with some embodiments of the presently disclosed subject matter.

FIG. 7b is a side plan view of an upwardly tilted device in accordance with some embodiments of the presently disclosed subject matter.

FIG. 7c is a side plan view of a downwardly tilted device in accordance with some embodiments of the presently disclosed subject matter.

FIG. 8a is a top plan view of a device swiveled to the right in accordance with some embodiments of the presently disclosed subject matter.

FIG. 8b is a top plan view of a device swiveled to the left in accordance with some embodiments of the presently disclosed subject matter.

FIG. 9 is a front plan view a device with arrows indicated potential directions of movement relative to a support surface in accordance with some embodiments of the presently disclosed subject matter.

FIG. 10 is a side plan view of a device comprising an actuator in accordance with some embodiments of the presently disclosed subject matter.

FIG. 11 is a top plan view of a controller that can be used with the mounting system in accordance with some embodiments of the presently disclosed subject matter.

FIG. 12 is a side plan view of a device with one or more speakers, lights, and outlets in accordance with some embodiments of the presently disclosed subject matter.

FIG. 13 is a flow chart illustrating one method of installing the mounting system in accordance with some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

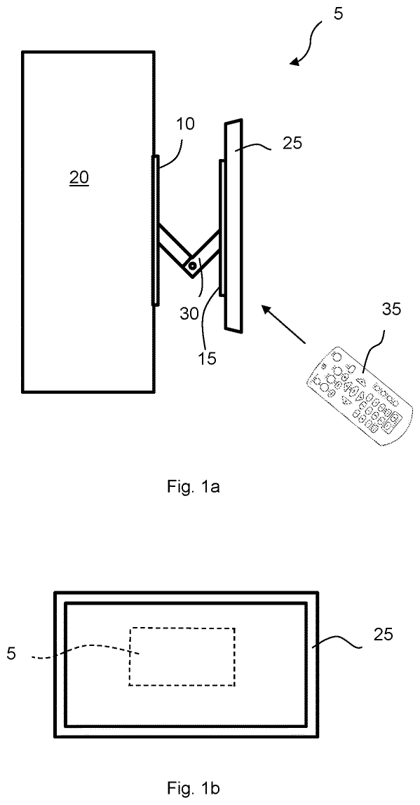

The presently disclosed subject matter is generally directed to a mounting system capable of allowing the user to remotely adjust the position of a television or other electrical device. The term “mounting system” refers to any device that allows for the support and mounting of a device on a support surface, such as a wall. As shown in FIG. 1a, mounting system 5 includes support bracket 10 that is mounted to support surface 20 (e.g., a wall). Device bracket 15 is releasably connected to device 25, which can be a flat screen television, computer screen, etc. The device bracket is operably attached to the support bracket via one or more adjustment arms 30. The adjustment arms have the capability to move device 25 in an upward, downward, left, and right direction, as well as tilt and swivel the device as desired by the user. Advantageously, the mounting system can be adjusted using controller 35 to allow a user to remotely operate the mounting system. In this way, device 15 can be extended to and from the support wall, tilted up and down, and swiveled or moved left and right using user input into the controller.

FIG. 1b is a front view illustrating device 15 mounted on wall 20 in a raised position, close to the wall. Mounting system 5 is hidden from view of a user in front of the television for an aesthetically pleasing appearance. However, the presently disclosed subject matter is not limited and can be used with medium or small screen devices such that the mounting system is visible.

Device 15 can include any element that can be mounted on a support structure. For example, the device can include televisions (e.g., LCD televisions, plasma televisions, LED televisions, and/or other flat screen televisions), gaming system screens, computer screens, speakers, stereo equipment, and the like. The device can further include non-electrical items, such as paintings and other similar items.

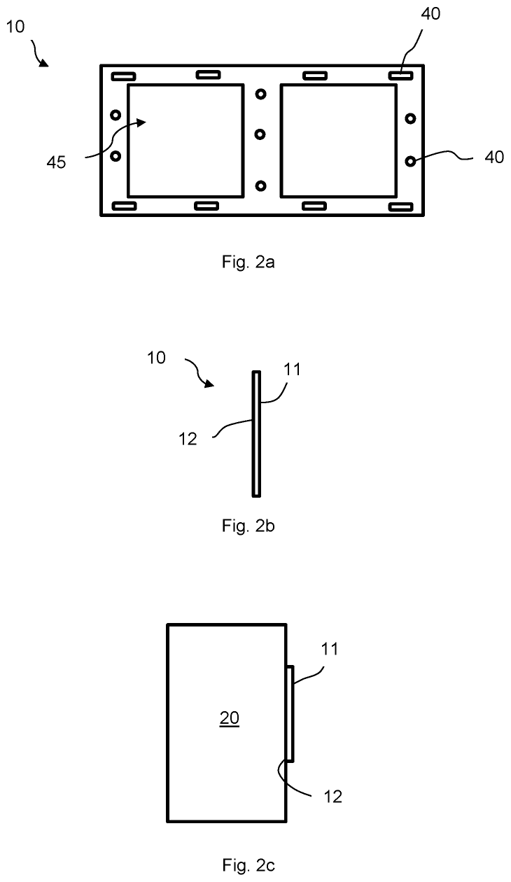

As set forth above, system 5 includes support bracket 10 that is mounted to a wall or other support structure. The term “bracket” refers to a one-piece or multi-piece structural support configured to be coupled to a structure, such as a wall. FIGS. 2a and 2b illustrate one embodiment of a support bracket that can be used in the disclosed system. As shown, the support bracket can include one or more apertures 40 that allow the bracket to be attached to support surface 20, such as through the use of one or more mechanical elements (e.g., screws, bolts, and the like). The apertures can be configured in any of a wide variety of shapes and sizes.

Optionally, support bracket 10 can include one or more openings 45 to ensure that the bracket is lightweight. Openings 45 also function to pass wires or cable through the support bracket, such as audio, video, or power cables. The cables can be connected to device 25, such as to supply power, audio, and/or video to a television.

Support bracket 10 includes front face 11 and opposed rear face 12. The rear face is positioned adjacent to a support surface when installed, as illustrated in FIG. 2c. Specifically, bracket 10 can be coupled to a wide range of different types of support structures 20, such as walls of a dwelling (e.g., a house, an apartment, store), an office, a fireplace, a lobby, a bar (e.g., a sports bar), or the like. The disclosed support bracket can be mounted to vertical walls or non-vertical walls, including, without limitation, angled walls, non-planar walls, or other structures sturdy enough to handle the load of mounting system 5 and any attached devices.

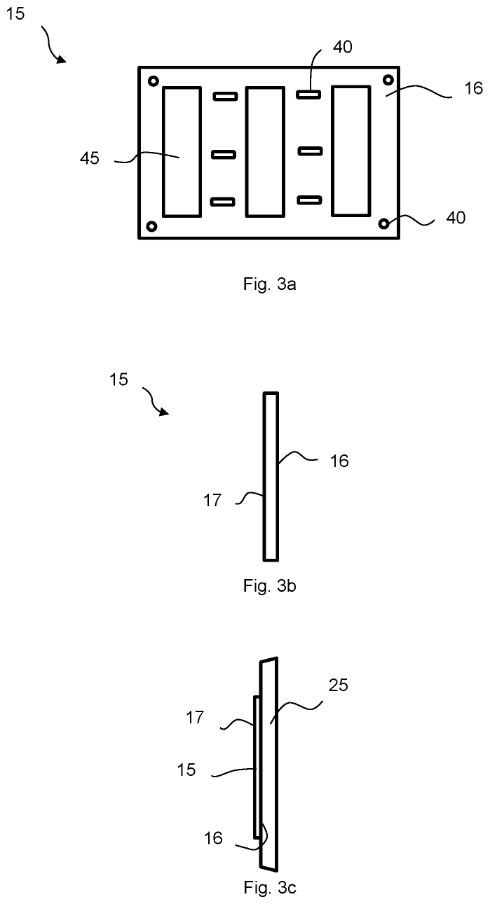

The disclosed system further includes device bracket 15 that is releasably attached to electrical device. FIGS. 3a-3c illustrate one embodiment of device bracket 15. As shown, the bracket can be configured as a flat plate with front face 16 that is positioned adjacent to the rear face of device 25. Rear face 17 opposes the front face and provides an attachment surface for arms 30, as described below. The device bracket can include one or more apertures 40 that allow the bracket to be releasably attached to the rear face of device 25 (e.g., screws, bolts, and the like). The “rear face” of device 25 refers to the non-viewing face of the device (e.g., the face opposing the viewing screen of a television). The device bracket can optionally include opening 45 that allows proper air circulation for the device and maintains the lightweight characteristic of the bracket.

It should be appreciated that the presently disclosed subject matter is not limited and the support bracket and device bracket can have any desired configuration. Brackets 10, 15 can further be configured in any desired size. Specifically, the size of the brackets can vary based on the size of the device mounted using the disclosed system. In some embodiments, the support bracket and device bracket can be about the same size. Alternatively, support bracket 10 can be larger or smaller (e.g., about 5-70 percent larger or smaller) than corresponding device bracket 25. However, the presently disclosed subject matter is not limited and the brackets can include sizes that are outside the stated range.

It should be appreciated that support bracket 10 and device bracket 15 can be configured in any desired shape, such as square, rectangular, oval, circular, triangular, pentagonal, hexagon, octagonal, abstract, and the like. Thus, the design of brackets 10, 15 is not limited and can be configured in any desired size, shape, or with additional features not described herein. In some embodiments, the support and device brackets can be universal brackets that allow most makes and models of televisions (or other devices) to be used with the disclosed system.

The support and device brackets can be constructed from any desired resilient material. For example, the brackets can be constructed from metal (e.g., stainless steel, aluminum), composite, wood, plastic, or combinations thereof.

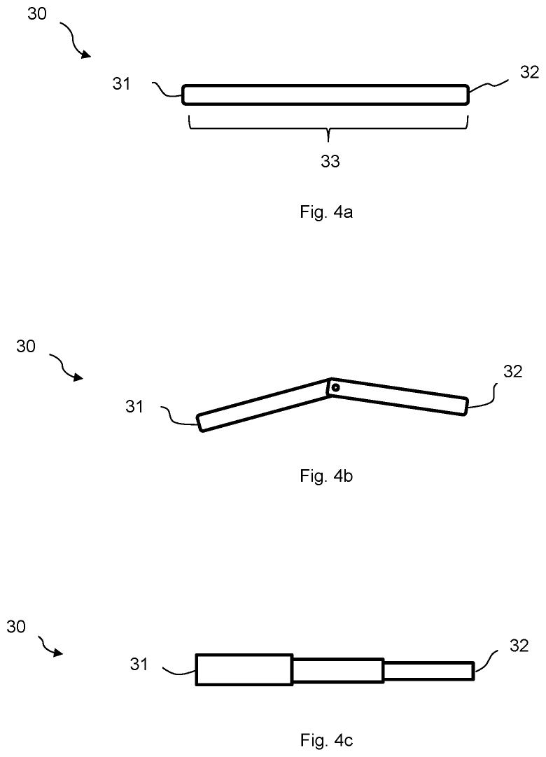

As described above, one or more arms 30 allow the device to be adjusted as desired by the user. The adjustment arm includes first end 31 and second end 32 with body 33 therebetween, as shown in FIG. 4a. The term “arm” broadly refers to any element that enables the device to move relative to the support and support bracket.

In some embodiments, the adjustment arm can include a hinged configuration to allow the device bracket to be adjusted toward and away from the support bracket, as shown in FIG. 4b. Alternatively, arm 30 can be configured with a telescoping arrangement as shown in FIG. 4c. However, it should be appreciated that any mechanism can be used to move the device bracket relative to the support bracket.

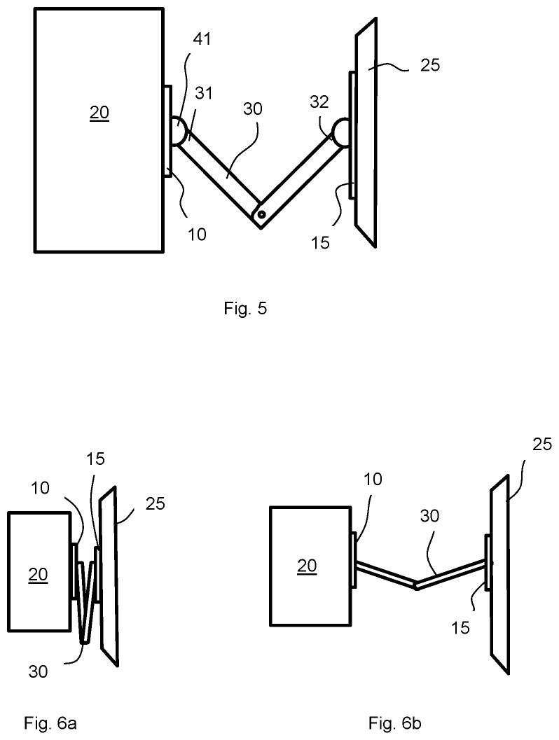

First end 31 of the adjustment arm is attached to front face 11 of the support bracket. Second end 32 of the adjustment arm is attached to rear face 17 of the device bracket, as illustrated in FIG. 5. Any element can be used to attach arm 30 to the support and/or device brackets, such as magnets, ties, screws, bolts, welding, adhesive, hooks, and the like. In some embodiments, each arm end is attached to a corresponding bracket 10, 15 at joint 41 to allow the arm to freely move and rotate as needed. Joint 41 can have any known configuration, such as a hinge, moveable section, extender, roller, ball, etc.

Arm 30 can be constructed from a rigid material, such as metal (e.g., steel, aluminum, stainless steel), composites, plastic, polymers, or combinations thereof.

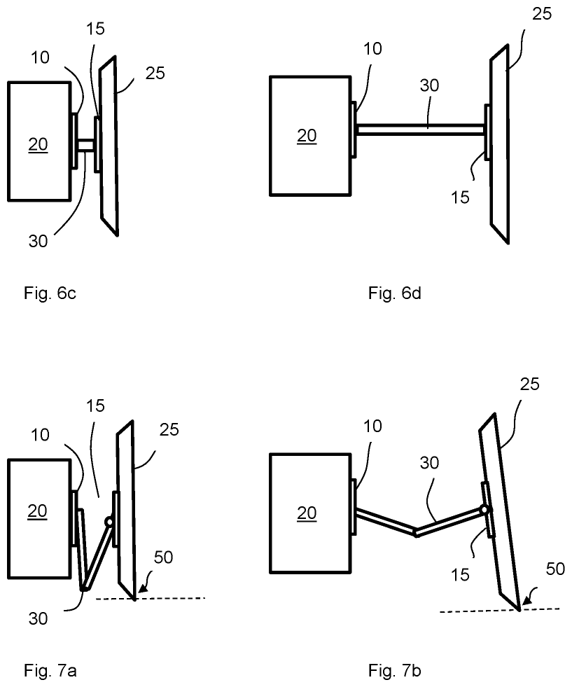

Arm 30 is capable of moving device 25 toward and away from the support. For example, arm 30 can fold and straighten to move the device toward and away from the support wall, as shown in FIGS. 6a and 6b. Alternatively, the arm can move in and out through a telescoping motion, as shown in FIGS. 6c and 6d. Any method of extending device 25 toward and away from support 25 can be used. The path of the device can be straight, angled, curved, arcuate, elliptical, etc. In this way, the disclosed system can easily and efficiently move device 25 a desired distance from the support. The device can travel any suitable distance, such as about 1-24 inches.

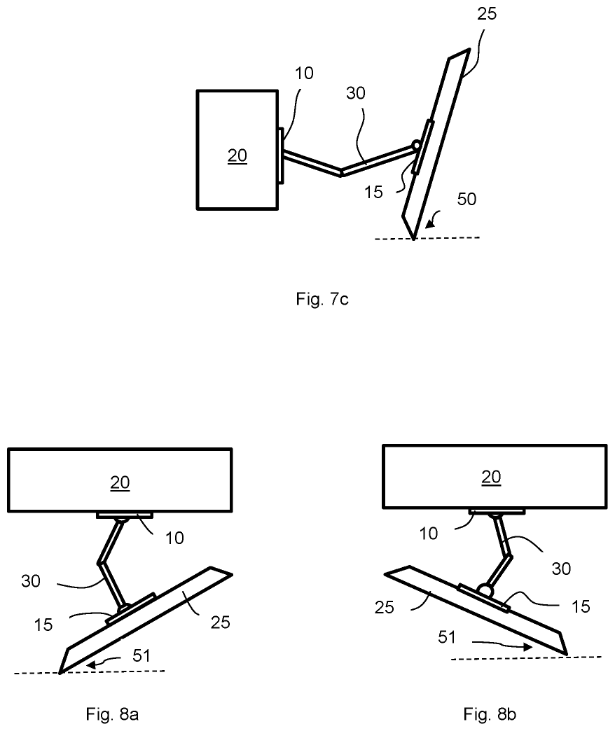

The disclosed system further allows device 25 to tilt to allow for the best viewing by a user. For example, in some embodiments, arm 30 allows the device to be tilted in an upward or downward direction. The term “tilt” refers to the operation of rotating the device in the upward and downward directions (e.g., rotation about a horizontal axis). FIG. 7a illustrates one embodiment of device 25 in a non-tilted position (e.g., with angle 50 of about 90 degrees relative to the horizontal). However, the device can be tilted in an upward or downward direction, as shown in FIGS. 7b and 7c, respectively. Particularly, when tilted in an upward direction, angle 50 can be obtuse. The term “obtuse” refers to an angle of greater than 90 degrees. The obtuse angle shown in FIG. 7b can be about 91-150 degrees (e.g., at least/no more than about 91, 95, 100, 105, 110, 115, 120, 125, 130, 135, 140, 145, or 150 degrees relative to the horizontal).

When tilted in a downward direction (as shown in FIG. 7c), angle 50 can be acute. The term “acute” refers to an angle of less than 90 degrees (e.g., rotation about a horizontal axis). The acute angle shown in FIG. 7c can be about 30-89 degrees (e.g., at least/no more than about 30, 35, 40, 45, 50, 55, 60, 65, 70, 75, 80, 85, or 89 degrees relative to the horizontal).

Therefore, the disclosed system allows device 25 to be angled such that the screen is at a desired angle relative to the viewer's line of sight. For example, the device can be angled forwardly or rearwardly (as described above) or can be flat against a wall (e.g., parallel to the wall) to minimize or limit unwanted reflections from the device screen that can be directed to a viewer sitting in front of the device, especially when the device is turned off.

The disclosed system also allows device 25 to be swiveled to the right or left (e.g., angled to the right or to the left), as shown in the overhead views of FIGS. 8a and 8b. The term “swivel” refers to the rotation in the left and right directions (e.g., rotation about a vertical axis). For example, arm 30 can allow the device to pivot to the left and/or right at any desired angle 51. In some embodiments, angle 51 can be about 1-70 degrees (e.g., at least/no more than about 1, 5, 10, 15, 20, 25, 30, 35, 40, 45, 50, 55, 60, 65, 70 or 75 degrees) relative to a straight configuration.

In some embodiments, device 25 can be tilted and swiveled simultaneously. For example, the device can be swiveled to the right and tilted in an upward direction at the same time.

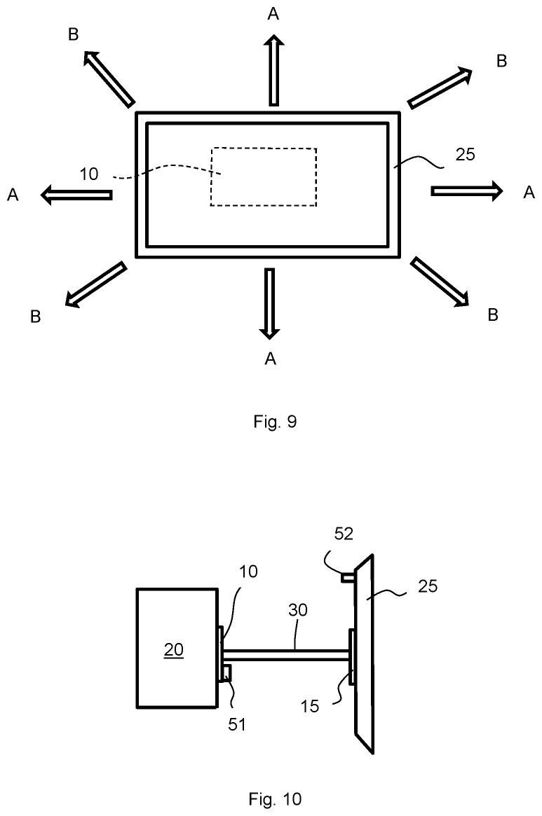

In addition to moving away from support wall 20 and tilting in a desired direction, the disclosed system also allows the device to be moved to be moved up, down, left, right directions relative to support 20 (and device bracket 10), as shown by Arrows A in FIG. 9. The device can also be angled (e.g., can move in a northwest direction), as shown by Arrows B.

In addition to moving away from support wall 20 and tilting in a desired direction, the disclosed system also allows the device to be moved to be moved up, down, left, right directions, as shown by Arrows A in FIG. 9. The device can also be angled (e.g., can move in a northwest direction), as shown by Arrows B.

Movement of arm 30 to relocate, tilt, extend, etc. device 25 can be accomplished through any known mechanism. For example, in some embodiments, the system can include one or more actuators 51 that can be activated to extend, swivel, retract, and/or tilt the device relative to the support surface, as shown in FIG. 10. The term “actuator” refers to any element that facilitates movement of arm 30 in a desired direction or manner. In some embodiments, the actuator can include a motor that is coupled to a screw to rotate the screw about its longitudinal axis or a pivot joint. However, it should be appreciated that any mechanism can be used to move the device. The actuator can be positioned on the control arm, support bracket, device bracket and/or can rest on device 25. In some embodiments, the actuator can receive instructions from receiver 52.

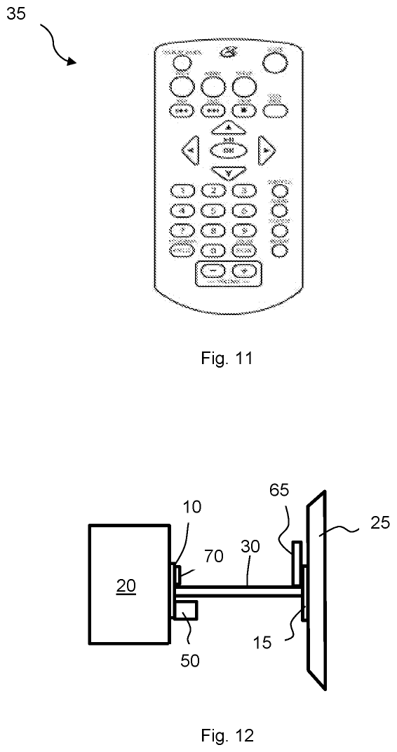

As described above, movement of the arm (via actuator 51) can be operated through controller 35. Particularly, a user can use the controller to move the location of the device, tilt the device, and/or adjust the position of the device relative to support surface 20. FIG. 11 illustrates one embodiment of controller 35 that can be used with the disclosed system. The controller can be any handheld element that allows a user to remotely control mounting system 10. For example, the actuator can receive instructions from receiver 52 that is communicatively coupled (e.g., wirelessly coupled, capacitively coupled, inductively coupled, etc.) to a transmitter in the controller. The controller can store information in memory and can include one or more computing devices or processors. The controller memory can include a variety of information, such as (but not limited to) settings, weight of device 25, position settings (stowed positions, lowered or raised positions, swiveled positions, tilted positions, favorites), and the like.

In some embodiments, the controller can include timed settings. For example, the television can automatically be stowed at a predetermined time. Alternatively, the system can be set to angle the device at a preset tilt, swivel, and/or location to correspond with a sporting event to be viewed. It should be appreciated that any of a wide variety of settings can be preset by the user for an assortment of events or occurrences.

In addition to have preset positions, the controller can allow a user to adjust the settings desired to fit a particular need. For example, each setting can include a different indicator (number, code, etc.) that can be entered into controller 35. In some embodiments, the controller can include arrows or other buttons to allow the user to adjust the system settings. The controller can comprise an input device, such as a touch pad, a touch screen, keyboard, etc. A user can use the input device to move the device via system 5 into various positions without having to manually adjust the device. In some embodiments, each controller can guide one or more devices 25, such as in a bar that includes a plurality of televisions. In this way, each television can be selected and individually customized for tilt (rotation up and down), distance from the support surface, location (left and right and/or up and down), swivel (rotation from side to side), and the like.

In some embodiments, the controller can be electronically controlled. However, in other embodiments, the controller can be battery powered.

The disclosed mount can support a device with a weight of about 20-110 pounds (e.g., at least/no more than about 20, 30, 40, 50, 60, 70, 80, 90, 100, or 100 pounds). However, the presently disclosed subject matter is not limited and the disclosed system can be used with one or more devices outside the weight range given above.

The different components of system 5 (e.g., the brackets and support arm) can be formed using any conventional method, such as (but not limited to), stamping, machining, thermoforming, welding, and the like.

Mounting system 5 can optionally include one or more additional features. For example, the system can include lights 60, speakers 65, and/or an electrical outlet 70 to allow for the attachment of additional devices, as shown in FIG. 12. The optional elements can be attached to one or more brackets, arm 30, or combinations thereof.

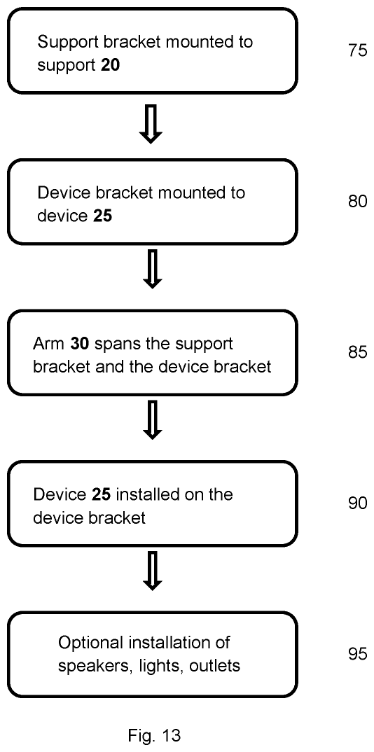

The disclosed system can be mounted at a desired location, as illustrated in the flow chart of FIG. 13. Particularly, support bracket 10 can be mounted to a support surface, such as a wall at step 75. As described above, any conventional method of mounting the bracket to support surface 20 can be used, such as the use of screws, bolts, and the like. Either of steps 75 or 80 can occur first. Device bracket 15 can also be mounted to device 25 using conventional methods at step 80. At step 85, arm 30 extends between the brackets and controls movement of the device relative to the support bracket. Device 25 can be installed on device bracket 15 to mount the device at step 90. Optional lights, speakers, and/or outlets can then be installed on the system at step 95.

A user can use controller 35 to move the device to the left or right, extend it towards or away from the support surface, swivel the device, and/or tilt the device up/down/left/right. Advantageously, the device can be adjusted remotely without the user having to manipulate the system or device. The controller can further be used to turn the device on/off, control the volume, change the channel, etc.

In some embodiments, the system can be manually adjusted as well, if desired by the user. For example, the user can manually grasp device 25 and pull it away from a wall, move it horizontally, swivel it, and/or tilt it. A user can also manually turn the volume up, etc.

The disclosed system offers many advantages over the prior art. For example, system 5 is aesthetically pleasing and is capable of hiding the system components behind device 25 so that they are hidden from view.

System 5 provides easy and secure attachment of device 25 to a wall or other support. In this way, the system avoids occupying usable space and reduces the likelihood of unwanted inadvertent contact by people moving about the room.

In addition, because system 5 is hidden from view behind the television, it is difficult for small children to reach up and pull down on the device.

The disclosed system further allows for the position of the device to be adjusted remotely, through controller 25. The controller can perform a variety of functions, such as adjusting the angle of the device, tilt of the device, swivel of the device, and/or position of the device relative to the support surface (e.g., wall upon which the system is mounted). Accordingly, the user is not required to manually manipulate the device to a desired position.

The disclosed system can allow the user to program various settings based on time, user (child versus adult), event (movie versus sports program), and the like.

The foregoing descriptions have been presented for purposes of illustration and description and are not intended to be exhaustive or to limit the presently disclosed subject matter. Many modifications and variations are possible in light of the present disclosure.

What is claimed is:

1. A device mounting system comprising:
a support bracket comprises a front face and an opposed rear face, wherein the rear face is configured to releasably attach to a support;
a device bracket comprises a front face and an opposed rear face, wherein the front face is configured to releasably attach to a device;
at least one adjustable arm comprising a first end attached to the front face of the support bracket and a second end attached to the rear face of the device bracket;
an actuator capable of moving the arm in a variety of positions;
a receiver capable of receiving signals from a controller and capable of giving instructions to the actuator;
a controller configured to remotely communicate with the receiver to control movement of the adjustable arm as desired by the user;
wherein the adjustable arm is configured to move the device in an upward direction, downward direction, tilted direction, swivel direction, or combinations thereof in response to input from the controller.

2. The system of claim 1, wherein the device is selected from a television, gaming system screen, computer screen, stereo speaker, or combinations thereof.

3. The system of claim 1, wherein the system includes a plurality of adjustment arms.

4. The system of claim 1, wherein the at least one adjustment arms are selected from a hinged configuration, straight configuration, a telescoping configuration, or combinations thereof.

5. The system of claim 1, wherein the actuator is configured to move the adjustment arm to position the device up, down, left, right, or combinations thereof relative to the support.

6. The system of claim 1, wherein the actuator is configured to move the adjustment arm to tilt the device up, down, or both.

7. The system of claim 1, wherein the actuator is configured to move the adjustment arm to swivel the device to the right, left, or both.

8. The system of claim 6, wherein the device is tilted at an acute angle or an obtuse angle.

9. The system of claim 7, wherein the device is swiveled at an angle of about 1-70 degrees.

10. The system of claim 1, wherein the actuator is configured to move the adjustment arm to:
tilt the device up, down, or both; and
swivel the device left, right, or both.

11. The system of claim 1, wherein the controller is wireless.

12. The system of claim 1, wherein the controller includes memory selected from prior adjustable arm settings, weight of the device, timer, or combinations thereof.

13. The system of claim 1, further comprising one or more lights, speakers, outlets, or combinations thereof.

14. A method of remotely adjusting the position of a device, the method comprising:
positioning the device on a mounting system, the mounting system comprising:
a support bracket comprises a front face and an opposed rear face, wherein the rear face is configured to releasably attach to a support;
a device bracket comprises a front face and an opposed rear face, wherein the front face is configured to releasably attach to a device;
an adjustable arm comprising a first end attached to the front face of the support bracket and a second end attached to the rear face of the device bracket;
an actuator capable of moving the arm in a variety of positions;
a receiver capable of receiving signals from a controller and capable of giving instructions to the actuator;
a controller configured to remotely communicate with the receiver to control movement of the adjustable arm as desired by the user;
wherein the adjustable arm is configured to move the device in an upward direction, downward direction, tilted direction, swivel direction, or combinations thereof in response to input from the controller;
inputting information into the controller as desired by the user, wherein the inputted information is received by the receiver;
moving the adjustment arm to position the device in accordance with the information input into the controller;
whereby the device is remotely adjusted.

15. The method of claim 14, wherein the device is selected from a television, gaming system screen, computer screen, stereo speaker, or combinations thereof.

16. The method of claim 14, wherein the actuator is configured to move the adjustment arm:
to position the device up, down, left, right, or combinations thereof relative to the support;
to tilt the device up, down, or both; and
to swivel the device to the right, left, or both.

17. The method of claim 14, wherein the device is tilted at an acute angle or an obtuse angle.

18. The method of claim 14, wherein the device is swiveled at an angle of about 1-70 degrees.

19. The method of claim 14, wherein the controller is wireless.

20. The method of claim 14, wherein inputting information into the controller comprises choosing a memory selected from prior adjustable arm settings, weight of the device, timer, or combinations thereof.
